(19) United States
(12) Patent Application Publication
(10) Pub. No.: US 2016/0069980 A1
(43) Pub. Date: Mar. 10, 2016

(54) WIRELESS COMMUNICATION DEVICE AND ESTIMATION METHOD

(71) Applicant: FUJITSU LIMITED, Kawasaki-shi (JP)

(72) Inventors: Kenichi NISHIKAWA, Kawasaki (JP); Kazuyuki Ozaki, Yokohama (JP)

(21) Appl. No.: 14/750,624

(22) Filed: Jun. 25, 2015

(30) Foreign Application Priority Data
Sep. 9, 2014 (JP) 2014-183649

(51) Int. Cl. G01S 3/74

(52) U.S. Cl. CPC G01S 3/74

(57) ABSTRACT

A wireless communication device includes: a plurality of antennas configured to receive a radio wave; a processor configured to execute a program; and a memory configured to store the program, wherein the processor preforms operations to: measure reception strength of a radio wave of an estimation target at each of the plurality of antennas; executes first calculation processing of calculating first correlation coefficients of antenna pairs among the plurality of antennas and calculating a second correlation coefficient of the plurality of antennas by using the first correlation coefficients for each of a plurality of direction-of-arrival candidates of the radio wave; and estimates a first direction of arrival of the radio wave of the estimation target based on the second correlation coefficient for each of the direction-of-arrival candidates.

### CROSS-REFERENCE TO RELATED APPLICATION

This application is based upon and claims the benefit of priority of the prior Japanese Patent Application No. 2014-183649, filed on Sep. 9, 2014, the entire contents of which are incorporated herein by reference.

### FIELD

The embodiments discussed herein are related to a wireless communication device and an estimation method.

### BACKGROUND

The direction of the arrival of radio waves is estimated.

A related art is disclosed in Japanese Laid-open Patent Publication No. 2004-257820, Japanese Laid-open Patent Publication No. 2006-234767, and non-patent document 1, Eddy Taillefer et al., “Direction-of-Arrival Estimation Using Radiation Power Pattern With an ESPAR Antenna,” IEEE TRANSACTION ON ANTENNAS AND PROPAGATION, February 2005, VOL. 53, NO. 2.

### SUMMARY

According to an aspect of the embodiment, a wireless communication device includes: a plurality of antennas configured to receive a radio wave; a processor configured to execute a program; and a memory configured to store the program, wherein the processor preforms operations to: measure reception strength of a radio wave of an estimation target at each of the plurality of antennas; executes first calculation processing of calculating first correlation coefficients of antenna pairs among the plurality of antennas and calculating a second correlation coefficient of the plurality of antennas by using the first correlation coefficients for each of a plurality of direction-of-arrival candidates of the radio wave; and estimates a first direction of arrival of the radio wave of the estimation target based on the second correlation coefficient for each of the direction-of-arrival candidates.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates one example of a wireless communication device;

FIG. 2 illustrates one example of a control unit;

FIG. 3 illustrates one example of processing of a wireless communication device;

FIG. 4 illustrates one example of an average estimation error;

FIG. 5 illustrates one example of a wireless communication device;

FIG. 6 illustrates one example of a control unit;

FIG. 7 illustrates one example of processing of a wireless communication device;

FIG. 8 illustrates one example of an estimation error;

FIG. 9 illustrates one example of an estimation error; and

FIG. 10 illustrates one example of a hardware configuration of a wireless communication device.

### DESCRIPTION OF EMBODIMENTS

The direction of the arrival of radio waves is estimated by using an array antenna. The method for estimating the direction of the arrival of radio waves by using an array antenna may be e.g. multiple signal classification (MUSIC), estimation of signal parameters via rotational invariance techniques (ESPRIT), or the like. In the MUSIC or ESPRIT, processing with a large amount of calculation, such as eigenvalue expansion, is executed. In addition, many kinds of processing are executed in order to acquire phase information of received radio waves used for calculation at the time of reception of radio waves.

To reduce the amount of processing taken for the direction-of-arrival estimation, the direction-of-arrival estimation is carried out by utilizing the reception strength (received signal strength indicator (RSSI)) of a signal received by a directional antenna.

A wireless communication device used in the direction-of-arrival estimation method with use of the reception strength includes a “directional antenna group” in which directional antennas are so disposed as to be different from each other in the direction of high receiving sensitivity. The wireless communication device stores a “reference table” in which plural “direction-of-arrival candidates” of radio waves are associated with reception strength expectations of the respective directional antennas according to each direction-of-arrival candidate. For example, the placement direction of a transmission source of radio waves is sequentially moved and the reception strength of each directional antenna is measured in advance regarding the respective placement directions. The measured reception strength is stored in the “reference table” as the reception strength expectations of each direction-of-arrival candidate. The wireless communication device calculates a “correlation coefficient of the unit of the directional antenna group” regarding each direction-of-arrival candidate by using the following expression (1). For example, for each direction-of-arrival candidate, the “correlation coefficient of the unit of the directional antenna group” is calculated by using expression (1). In expression (1), a calculation expression of the “correlation coefficient of the unit of the directional antenna group” when the directional antenna group is four directional antennas is represented.

$$ρ = \frac{\begin{matrix}( {ref}_{1} \times {RSSI}_{1} ) + ( {ref}_{2} \times {RSSI}_{2} ) + \\ ( {ref}_{3} \times {RSSI}_{3} ) + ( {ref}_{4} \times {RSSI}_{4} )\end{matrix}}{\begin{matrix}\sqrt{{\vert {ref}_{1} \vert}^{2} + {\vert {ref}_{2} \vert}^{2} + {\vert {ref}_{3} \vert}^{2} + {\vert {ref}_{4} \vert}^{2} \times } \\ \sqrt{{\vert {RSSI}_{1} \vert}^{2} + {\vert {RSSI}_{2} \vert}^{2} + {\vert {RSSI}_{3} \vert}^{2} + {\vert {RSSI}_{4} \vert}^{2}}\end{matrix}} \qquad ( 1 )$$

The symbol ref denotes the reception strength expectation stored in the reference table and ref₁ denotes the reception strength expectation of antenna 1. RSSI denotes the measured present reception strength and RSSI₁ denotes the present reception strength of antenna 1.

For example, in the direction-of-arrival estimation method with use of the reception strength, a bias in the degree of influence on the “correlation coefficient of the unit of the directional antenna group” might be caused among the directional antennas and the calculation accuracy of the “correlation coefficient of the unit of the directional antenna group” might decrease.

For example, by dividing the denominator and the numerator by “ref₁×RSSI₁” in expression (1), expression (1) is modified to the following expression (2).

$$ρ = \frac{1 + ( \frac{{ref}_{2}}{{ref}_{1}} \times \frac{{RSSI}_{2}}{{RSSI}_{1}} ) + ( \frac{{ref}_{3}}{{ref}_{1}} \times \frac{{RSSI}_{3}}{{RSSI}_{1}} ) + ( \frac{{ref}_{4}}{{ref}_{1}} \times \frac{{RSSI}_{4}}{{RSSI}_{1}} )}{\begin{matrix}\sqrt{1 + {( \frac{{ref}_{2}}{{ref}_{1}} )}^{2} + {( \frac{{ref}_{3}}{{ref}_{1}} )}^{2} + {( \frac{{ref}_{4}}{{ref}_{1}} )}^{2}} \times \\ \sqrt{1 + {( \frac{{RSSI}_{2}}{{RSSI}_{1}} )}^{2} + {( \frac{{RSSI}_{3}}{{RSSI}_{1}} )}^{2} + {( \frac{{RSSI}_{4}}{{RSSI}_{1}} )}^{2}}\end{matrix}} \qquad ( 2 )$$

If ref₁ and ref₂ are sufficiently larger than ref₃ and ref₄ and RSSI₁ and RSSI₂ are sufficiently larger than RSSI₃ and RSSI₄, the third term and the fourth term in the numerator become almost zero. Furthermore, the third term and the fourth term in the former root in the denominator also become almost zero and the third term and the fourth term in the latter root also become almost zero. Therefore, directional antenna 3 and directional antenna 4 might have little influence on the “correlation coefficient of the unit of the directional antenna group.”

In the embodiments, a configuration having substantially the same or similar function might be given the same numeral and overlapping description might be omitted or reduced.

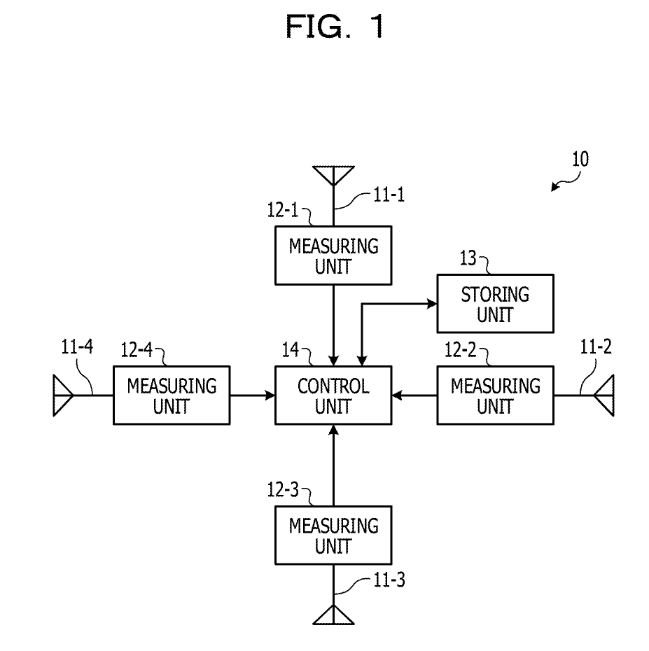

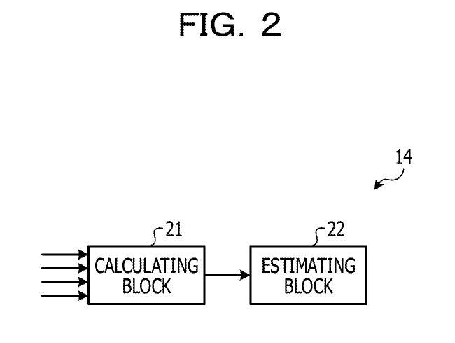

FIG. 1 illustrates one example of a wireless communication device. A wireless communication device 10 illustrated in FIG. 1 includes directional antennas 11-1 to 11-4, measuring units 12-1 to 12-4, a storing unit 13, and a control unit 14. FIG. 2 illustrates one example of a control unit. The control unit illustrated in FIG. 2 may be the control unit 14 illustrated in FIG. 1. The control unit 14 illustrated in FIG. 2 includes a calculating block 21 and an estimating block 22. Hereinafter, if the directional antennas 11-1 to 11-4 are not discriminated, the directional antennas 11-1 to 11-4 might be collectively referred to as the directional antenna 11. The whole of the directional antennas 11-1 to 11-4 might be collectively referred to as the directional antenna group. If the measuring units 12-1 to 12-4 are not discriminated, the measuring units 12-1 to 12-4 might be collectively referred to as the measuring unit 12. The number of pairs of the directional antenna 11 and the measuring unit 12 may be four or may be another arbitrary number.

The directional antennas 11-1 to 11-4 are so disposed as to be different from each other in the direction of high receiving sensitivity. Each directional antenna 11 receives radio waves of a direction-of-arrival estimation target.

The measuring units 12-1 to 12-4 may correspond to the directional antennas 11-1 to 11-4, respectively. The measuring unit 12 measures the reception strength of radio waves received by the corresponding directional antenna 11 and outputs the value of the measured reception strength to the calculating block 21.

The storing unit 13 stores the reference table. The reference table holds plural direction-of-arrival candidates of radio waves and the reception strength expectations of the respective directional antennas 11 according to each direction-of-arrival candidate in association with each other. The reception strength expectations of the respective directional antennas 11 may be e.g. measured values obtained by measuring the reception strength of each directional antenna 11 in advance regarding the respective placement directions resulting from sequential movement of the placement direction of a transmission source of radio waves from a reference direction of the wireless communication device 10.

Regarding each direction-of-arrival candidate, the calculating block 21 carries out a first-stage calculation to calculate correlation coefficients of the unit of an antenna pair and a second-stage calculation to calculate a correlation coefficient of the unit of the directional antenna group. For example, the calculating block 21 may repeatedly carry out the first-stage calculation and the second-stage calculation while sequentially changing a target direction-of-arrival candidate among plural direction-of-arrival candidates.

In the first-stage calculation, the calculating block 21 calculates correlation coefficients of the unit of an antenna pair in the directional antenna group by using the reception strength expectations stored in the storing unit 13 and the reception strength measured by the respective measuring units 12. For example, the correlation coefficient may be calculated regarding each of an antenna pair of the directional antennas 11-1 and 11-2, an antenna pair of the directional antennas 11-1 and 11-3, an antenna pair of the directional antennas 11-1 and 11-4, an antenna pair of the directional antennas 11-2 and 11-3, an antenna pair of the directional antennas 11-2 and 11-4, and an antenna pair of the directional antennas 11-3 and 11-4.

Each correlation coefficient of the unit of an antenna pair regarding the target direction-of-arrival candidate is calculated by using the following expression (3).

$$f ( x , y , θ ) = \frac{( {ref}_{x} ( θ ) \times {RSSI}_{x} ) + ( {ref}_{y} ( θ ) \times {RSSI}_{y} )}{\sqrt{{\vert {ref}_{x} \vert}^{2} + {\vert {ref}_{y} \vert}^{2}} \times \sqrt{{\vert {RSSI}_{x } ( θ ) \vert}^{2} + {\vert {RSSI}_{y} ( θ ) \vert}^{2}}} \qquad ( 3 )$$

θ denotes an angle formed between the target direction-of-arrival candidate and the reference direction of the wireless communication device 10. The symbols refₓ(θ) and ref_{y}(θ) each correspond to a respective one of the reception strength expectations of two directional antennas 11 configuring a target antenna pair about the target direction-of-arrival candidate. RSSIₓ and RSSI_{y} each correspond to a respective one of the reception strength measured by the measuring units 12 regarding the two directional antennas 11 configuring the target antenna pair.

In the second-stage calculation, the calculating block 21 calculates the correlation coefficient of the unit of the directional antenna group regarding the target direction-of-arrival candidate based on the correlation coefficients of the unit of an antenna pair calculated in the first-stage calculation.

The correlation coefficient of the unit of the directional antenna group regarding the target direction-of-arrival candidate may be calculated by using the following expression (4). In expression (4), a calculation expression when the directional antenna group is composed of four directional antennas is represented.

ρ(θ)=f(1,2,θ)·f(1,3,θ)·f(1,4,θ)·f(2,3,θ)·f(2,4,θ)·f(3,4,θ) (4)

In the expression, f(1, 2, θ) represents the correlation coefficient of the unit of an antenna pair regarding the antenna pair of the directional antennas 11-1 and 11-2 about the target direction-of-arrival candidate whose angle formed with the reference direction of the wireless communication device 10 is θ.

For example, the calculating block 21 calculates the correlation coefficient of the unit of the directional antenna group regarding each direction-of-arrival candidate by calculating the product of the correlation coefficients of the unit of an antenna pair calculated regarding the respective direction-of-arrival candidates.

The calculating block 21 outputs, to the estimating block 22, the calculated values of the correlation coefficient of the unit of the directional antenna group regarding the respective direction-of-arrival candidates.

The estimating block 22 estimates the direction of the arrival of radio waves of the estimation target based on the values of the correlation coefficient of the unit of the directional antenna group regarding the respective direction-of-arrival candidates, received from the calculating block 21. For example, the estimating block 22 may estimate, as the direction of the arrival of radio waves of the estimation target, the direction-of-arrival candidate corresponding to the largest value among the values of the correlation coefficient of the unit of the directional antenna group regarding the respective direction-of-arrival candidates, received from the calculating block 21.

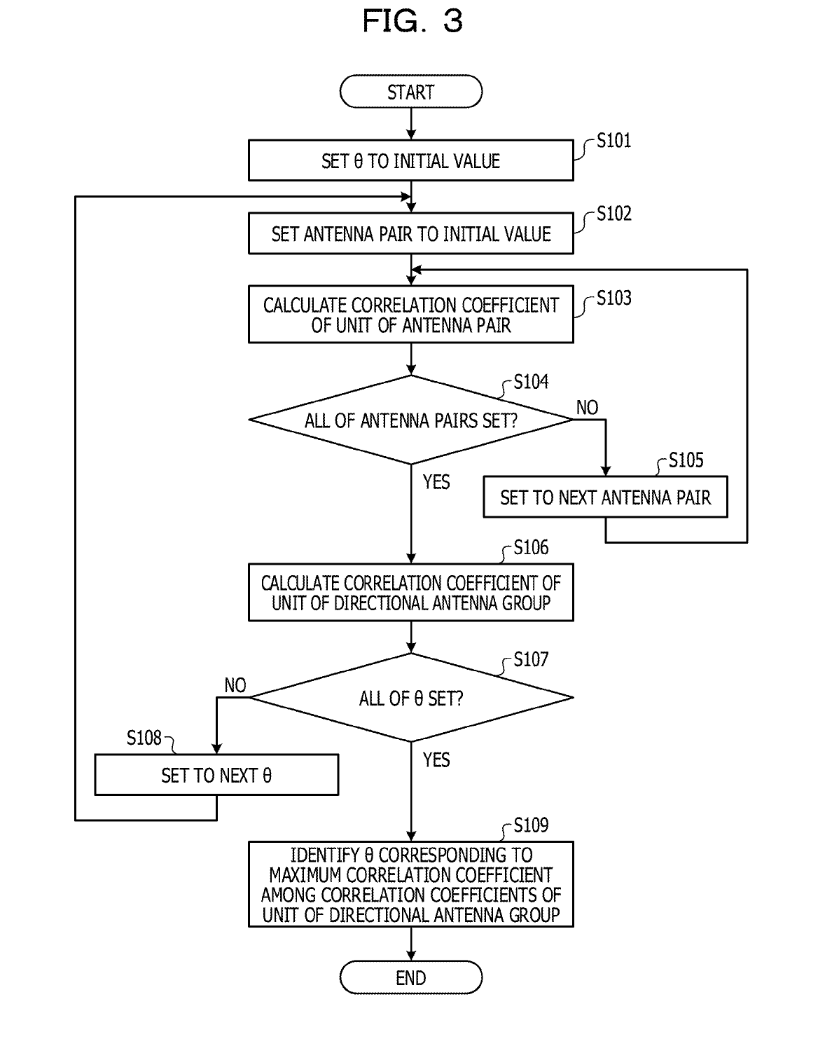

FIG. 3 illustrates one example of processing of a wireless communication device. The wireless communication device 10 illustrated in FIG. 1 may execute the processing illustrated in FIG. 3.

The calculating block 21 sets θ to an initial value (operation S101). For example, if the number of direction-of-arrival candidates θₖ is N (N is a natural number equal to or larger than two), the calculating block 21 sets the target direction-of-arrival candidate to a direction-of-arrival candidate θ₁.

The calculating block 21 sets the antenna pair to an initial value (operation S102). For example, if the number of directional antennas 11 is four, the calculating block 21 sets the target antenna pair to the antenna pair of the directional antennas 11-1 and 11-2 for example.

The calculating block 21 calculates the correlation coefficient of the unit of an antenna pair for the set target antenna pair (operation S103). For example, the calculating block 21 calculates the correlation coefficient of the unit of an antenna pair for the set target antenna pair by using the above expression (3).

The calculating block 21 determines whether or not all of the antenna pairs have been set (operation S104).

If the antenna pair that has not yet been set exists (No of the operation S104), the calculating block 21 sets the target antenna pair to the next antenna pair, for example, the antenna pair of the directional antennas 11-1 and 11-3 (operation S105). The operations S103 to S105 may be repeated until the calculation of the correlation coefficient of the unit of an antenna pair is completed for all of the antenna pairs.

If all of the antenna pairs have been set (Yes of the operation S104), the calculating block 21 calculates the correlation coefficient of the unit of the directional antenna group by using the correlation coefficients of the unit of an antenna pair repeatedly calculated in the operation S103 about the set target direction-of-arrival candidate (operation S106). For example, the calculating block 21 calculates the “correlation coefficient of the unit of the directional antenna group” by using expression (4).

The calculating block 21 determines whether or not all of θ have been set (operation S107). For example, the calculating block 21 determines whether or not the setting of all of θ from the direction-of-arrival candidate θ₁ to the direction-of-arrival candidate θ_{N} has been completed.

If the direction-of-arrival candidate θₖ that has not yet been set exists (No of the operation S107), the calculating block 21 sets the direction-of-arrival candidate θₖ to the next θ (operation S108). The operations S102 to S108 may be repeated until the calculation of the “correlation coefficient of the unit of the directional antenna group” is completed for all of the direction-of-arrival candidates θₖ.

If all of θ have been set (Yes of the operation S107), the estimating block 22 identifies θ corresponding to the maximum correlation coefficient among the correlation coefficients of the unit of the directional antenna group calculated by the calculating block 21 for all of θ (operation S109). For example, the estimating block 22 estimates, as the direction of the arrival of radio waves of the estimation target, the direction-of-arrival candidate θₖ corresponding to the maximum value among the values of the “correlation coefficient of the unit of the directional antenna group” regarding the respective direction-of-arrival candidates θₖ, received from the calculating block 21.

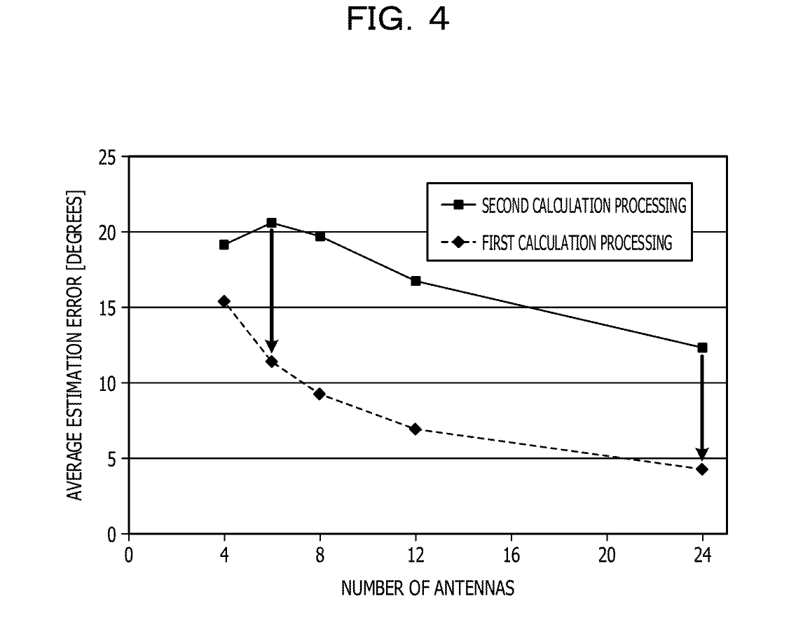

First calculation processing in which the correlation coefficient of the unit of the directional antenna group is calculated by the first-stage calculation and the second-stage calculation will be compared with second calculation processing in which the correlation coefficient of the unit of the directional antenna group is directly calculated by expression (1). FIG. 4 illustrates one example of an average estimation error. In FIG. 4, the abscissa axis indicates the number of directional antennas included in the wireless communication device and the ordinate axis indicates the average estimation error. In FIG. 4, values plotted by squares indicate the average estimation errors resulting from the second calculation processing and values plotted by diamonds indicate the average estimation errors resulting from the first calculation processing.

As illustrated in FIG. 4, whichever number the number of directional antennas included in the wireless communication device is, the average estimation error resulting from the first calculation processing is smaller than the average estimation error resulting from the second calculation processing. The estimation error might be improved by the first calculation processing.

In the wireless communication device 10, the calculating block 21 executes the first calculation processing including the first-stage calculation and the second-stage calculation. For example, in the first-stage calculation, the calculating block 21 calculates the correlation coefficients of the unit of an antenna pair in the directional antenna group by using the reception strength expectations stored in the storing unit 13 and the reception strength measured by the respective measuring units 12. In the second-stage calculation, the calculating block 21 calculates the correlation coefficient of the unit of the directional antenna group regarding the target direction-of-arrival candidate based on the correlation coefficients of the unit of an antenna pair calculated in the first-stage calculation. The estimating block 22 estimates the direction of the arrival of radio waves of the estimation target based on the values of the correlation coefficient of the unit of the directional antenna group regarding the respective direction-of-arrival candidates, calculated by the calculating block 21.

In the wireless communication device 10, the degree of influence on the correlation coefficient of the unit of the directional antenna group is leveled among the directional antennas 11. Therefore, the calculation accuracy of the correlation coefficient of the unit of the directional antenna group might be improved. The estimation accuracy of the direction of arrival might be enhanced.

In the second-stage calculation, the calculating block 21 calculates the correlation coefficient of the unit of the directional antenna group regarding each direction-of-arrival candidate by calculating the product of the correlation coefficients of the unit of an antenna pair calculated regarding the respective direction-of-arrival candidates.

The correlation coefficient of the unit of the directional antenna group regarding each direction-of-arrival candidate may be calculated by calculating the product of the correlation coefficients of the unit of an antenna pair. For example, through calculation of the sum instead of the product, the correlation coefficient of the unit of the directional antenna group regarding each direction-of-arrival candidate may be calculated. For example, the “correlation coefficient of the unit of the directional antenna group” may be calculated by using the following expression (5).

ρ(θ)=f(1,2,θ)+f(1,3,θ)+f(1,4,θ)+f(2,3,θ)+f(2,4,θ)+f(3,4,θ) (5)

For example, when the above-described second calculation processing is executed before the above-described first calculation processing and a given condition is satisfied, the first calculation processing may be executed.

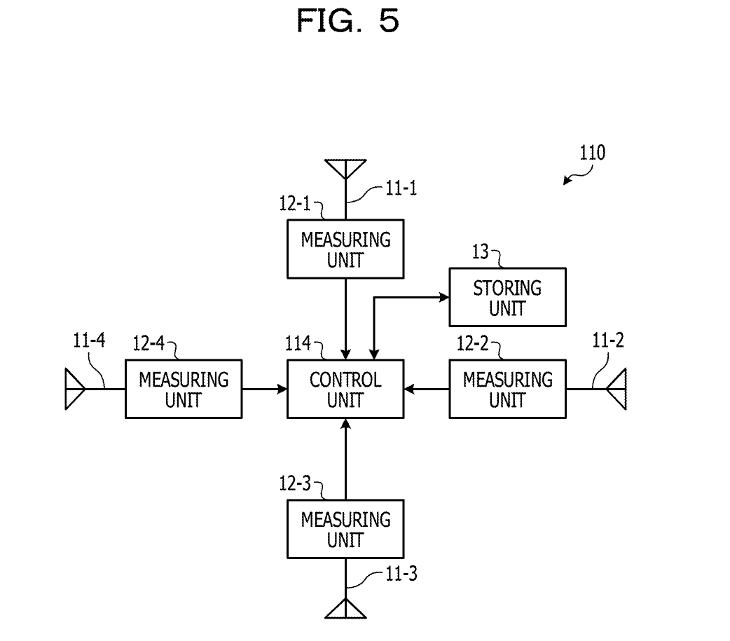

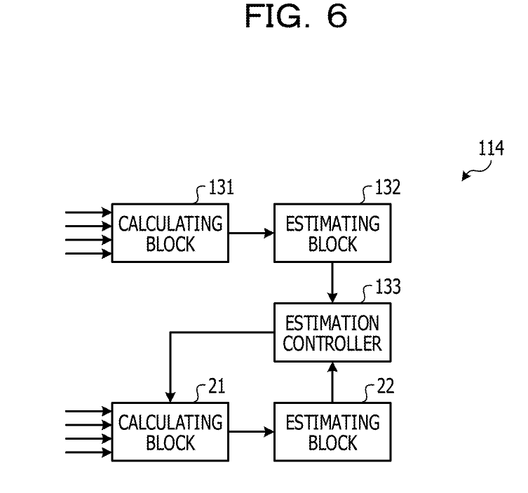

FIG. 5 illustrates one example of a wireless communication device. A wireless communication device 110 illustrated in FIG. 5 includes a control unit 114. FIG. 6 illustrates one example of a control unit. The control unit illustrated in FIG. 6 may be the control unit 114 illustrated in FIG. 5. The control unit 114 illustrated in FIG. 6 includes a calculating block 131, an estimating block 132, and an estimation controller 133.

Regarding each direction-of-arrival candidate, the calculating block 131 calculates the correlation coefficients of the unit of the directional antenna group regarding the respective direction-of-arrival candidates by using the reception strength expectations stored in the storing unit 13 and the reception strength measured by the measuring units 12. For example, the calculating block 131 calculates the correlation coefficients of the unit of the directional antenna group regarding the respective direction-of-arrival candidates by using expression (1) in the above-described second calculation processing.

The estimating block 132 estimates the direction of the arrival of radio waves of the estimation target based on the values of the correlation coefficient of the unit of the directional antenna group regarding the respective direction-of-arrival candidates, calculated by the calculating block 131. For example, the estimating block 132 may estimate, as the direction of the arrival of radio waves of the estimation target, the direction-of-arrival candidate corresponding to the largest value among the values of the correlation coefficient of the unit of the directional antenna group regarding the respective direction-of-arrival candidates, received from the calculating block 131.

If the given condition is satisfied, the estimation controller 133 causes the calculating block 21 to execute the first calculation processing and causes the estimating block 22 to execute the estimation processing. The estimation controller 133 employs the direction-of-arrival candidate estimated by the estimating block 22 as the direction of the arrival of radio waves of the estimation target. If the given condition is not satisfied, the estimation controller 133 employs the direction-of-arrival candidate estimated by the estimating block 132 as the direction of the arrival of radio waves of the estimation target.

For example, the given condition may include that the direction of arrival estimated by the estimating block 132 does not fall within a given angle range whichever antenna in the directional antenna group is selected as the antenna whose high receiving sensitivity direction serves as a reference, or that the direction of arrival estimated by the estimating block 132 falls within the given angle range based on the high receiving sensitivity direction of one antenna in the directional antenna group and the difference between the reception strength of the one antenna and the reception strength of an adjacent antenna of the one antenna is equal to or smaller than a threshold.

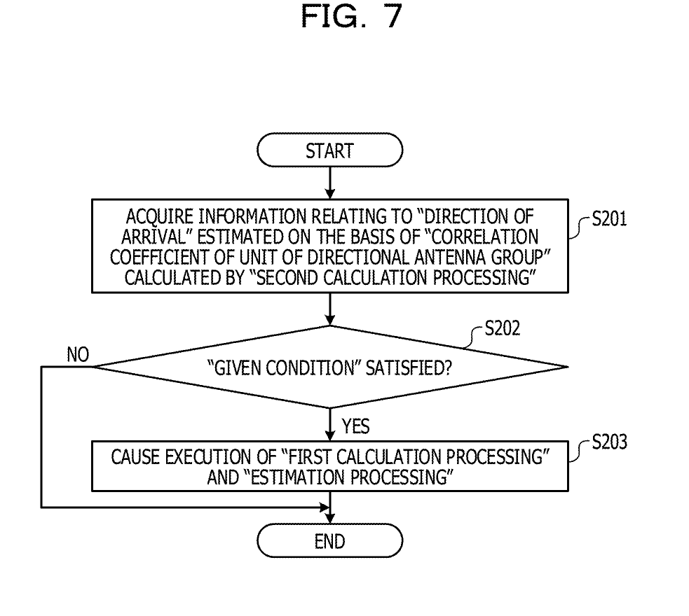

FIG. 7 illustrates one example of processing of a wireless communication device.

The estimation controller 133 acquires, from the estimating block 132, information relating to the direction of arrival estimated based on the correlation coefficients of the unit of the directional antenna group calculated in the second calculation processing (operation S201). For example, the estimation controller 133 acquires information relating to the direction of arrival estimated by the estimating block 132.

The estimation controller 133 determines whether or not the given condition is satisfied (operation S202). For example, the given condition may include that the direction of arrival estimated by the estimating block 132 does not fall within a given angle range whichever antenna in the directional antenna group is selected as the antenna whose high receiving sensitivity direction serves as the basis, or that the direction of arrival estimated by the estimating block 132 falls within the given angle range based on the high receiving sensitivity direction of one antenna in the directional antenna group and the difference between the reception strength of the one antenna and the reception strength of an adjacent antenna of the one antenna is equal to or smaller than a threshold.

If the given condition is satisfied (Yes of the operation S202), the estimation controller 133 causes the calculating block 21 to execute the first calculation processing and causes the estimating block 22 to execute the estimation processing (operation S203). The processing illustrated in FIG. 7 ends. If the given condition is not satisfied (No of the operation S202), the processing illustrated in FIG. 7 ends.

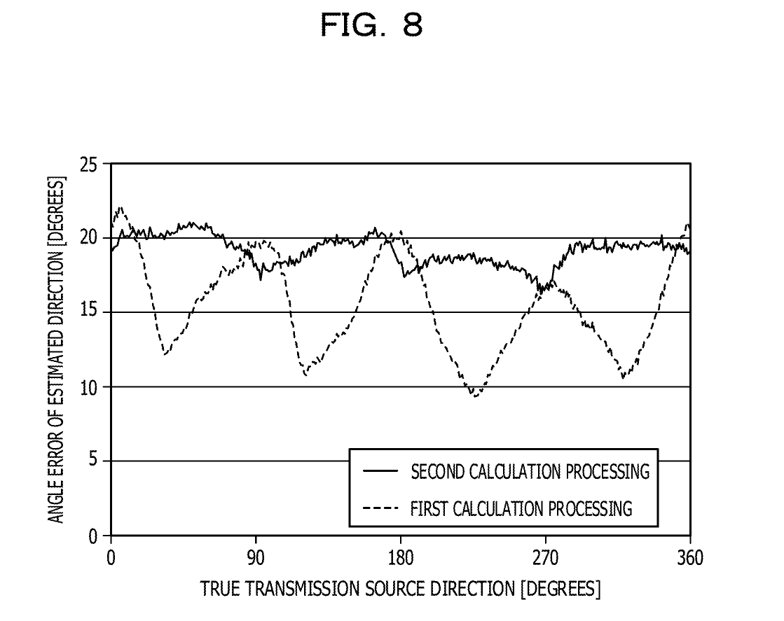

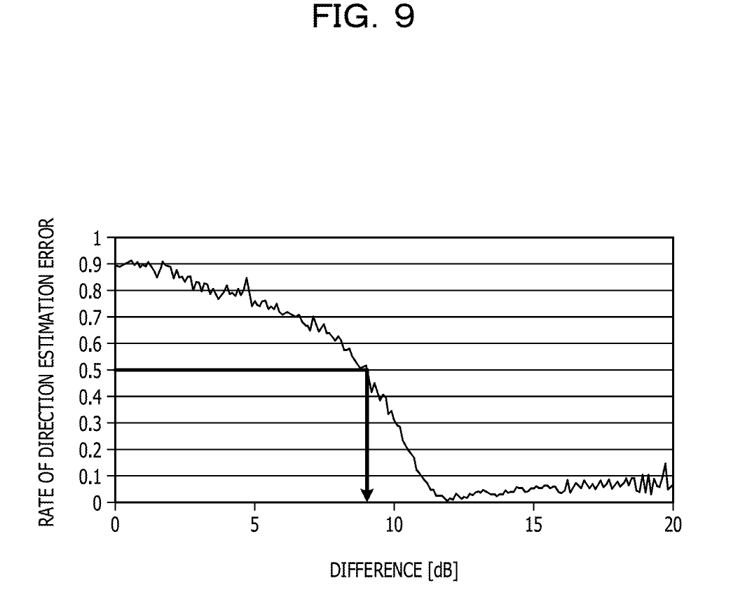

FIGS. 8 and 9 illustrate one example of an estimation error. FIG. 8 is a diagram illustrating estimation errors according to the direction of arrival estimated based on the respective kinds of calculation processing. As illustrated in FIG. 8, as the result of a simulation, if the direction of arrival falls within a given angle range based on the high receiving sensitivity direction of any antenna in the directional antenna group, the accuracy of the direction of arrival estimated based on the result of the second calculation processing is higher than the accuracy of the direction of arrival estimated based on the result of the first calculation processing.

FIG. 9 illustrates the superiority and inferiority of the estimation error based on the respective kinds of calculation processing according to the difference in the received power between the directional antenna having the highest reception strength and the directional antenna having the second highest reception strength. In FIG. 9, the abscissa axis indicates the difference in the received power between the highest reception strength and the second highest reception strength among the antennas. The ordinate axis indicates the rate at which the direction estimation error resulting from the first calculation processing is smaller than the direction estimation error resulting from the second calculation processing. As illustrated in FIG. 9, as the result of a simulation, when the difference in the received power between the directional antenna having the highest reception strength and the directional antenna having the second highest reception strength is larger than a threshold, the accuracy of the direction of arrival estimated based on the result of the second calculation processing is higher than the accuracy of the direction of arrival estimated based on the result of the first calculation processing.

Therefore, in the control by the estimation controller 133, either one of the first calculation processing and the second calculation processing may be selected as the calculation processing for enhancement in the estimation accuracy depending on the situation.

In the wireless communication device 110, the calculating block 21 executes the first calculation processing if the given condition is satisfied. The given condition may include that the direction of arrival estimated by the estimating block 132 does not fall within a given angle range whichever antenna in the directional antenna group is selected as the antenna whose high receiving sensitivity direction serves as the reference, or that the direction of arrival estimated by the estimating block 132 falls within the given angle range based on the high receiving sensitivity direction of one antenna in the directional antenna group and the difference between the reception strength of the one antenna and the reception strength of an adjacent antenna of the one antenna is equal to or smaller than a threshold.

In the wireless communication device 110, the first calculation processing is executed if the accuracy of the direction of arrival estimated based on the result of the first calculation processing is higher than the accuracy of the direction of arrival estimated based on the result of the second calculation processing. Therefore, the estimation accuracy might be improved and the amount of processing might be reduced.

The first calculation processing may be executed if the second calculation processing is executed before the first calculation processing and the given condition is satisfied. For example, the following estimation control may be carried out as a variation of the estimation control.

For example, the second calculation processing may be executed if the first calculation processing is executed and a second condition is satisfied. The second condition may include that the direction of arrival estimated by the estimating block 22 falls within a given angle range based on the high receiving sensitivity direction of any antenna in the directional antenna group, or that the difference in the received power between the directional antenna having the highest reception strength and the directional antenna having the second highest reception strength is larger than a threshold.

All or part of the above-described respective constituent elements may be distributed or integrated functionally or physically in an arbitrary unit according to various kinds of loads, the use condition, and so forth.

All or an arbitrary part of various kinds of processing functions carried out by the respective devices may be carried out on a central processing unit (CPU) or a microcomputer such as a micro processing unit (MPU) or a micro controller unit (MCU). All or an arbitrary part of the various kinds of processing functions may be carried out on a program analyzed and executed on a CPU or a microcomputer such as an MPU or MCU or on hardware based on wired logic.

The wireless communication device illustrated in FIG. 1 or FIG. 5 may be implemented by a hardware configuration for example.

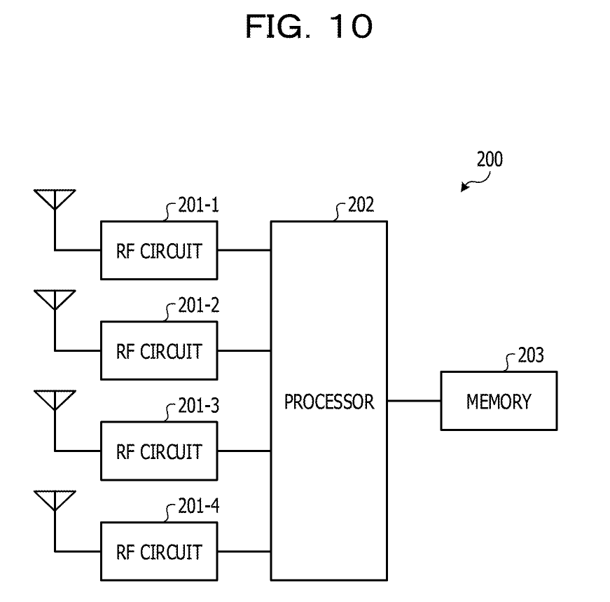

FIG. 10 illustrates one example of a hardware configuration of a wireless communication device. As illustrated in FIG. 10, a wireless communication device 200 includes radio frequency (RF) circuits 201-1 to 201-4, a processor 202, and a memory 203. As the processor 202, e.g. a CPU, a digital signal processor (DSP), a field programmable gate array (FPGA), or the like may be used. As the memory 203, a random access memory (RAM) such as a synchronous dynamic random access memory (SDRAM), a read only memory (ROM), a flash memory, or the like may be used. The wireless communication devices 10 and 110 illustrated in FIGS. 1 and 5 may have the configuration illustrated in FIG. 10.

The various kinds of processing functions carried out by the above-described wireless communication device may be implemented through execution of a program stored in various kinds of memories such as a non-volatile storage medium by a processor. For example, programs corresponding to the respective kinds of processing executed by the measuring units 12-1 to 12-4 and the control unit 14 or 114 may be recorded in the memory 203 and the respective programs may be executed by the processor 202. The directional antennas 11-1 to 11-4 may be implemented by the RF circuits 201-1 to 201-4. The storing unit 13 may be implemented by the memory 203.

The various kinds of processing functions carried out by the above-described wireless communication device may be carried out by the processor 202 or may be carried out by plural processors.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication device comprising:
a plurality of antennas configured to receive a radio wave;
a processor configured to execute a program; and
a memory configured to store the program,
wherein the processor preforms operations to:
measure reception strength of a radio wave of an estimation target at each of the plurality of antennas;
execute first calculation processing of calculating first correlation coefficients of antenna pairs among the plurality of antennas and calculating a second correlation coefficient of the plurality of antennas by using the first correlation coefficients for each of a plurality of direction-of-arrival candidates of the radio wave; and
estimate a first direction of arrival of the radio wave of the estimation target based on the second correlation coefficient for each of the direction-of-arrival candidates.

2. The wireless communication device according to claim 1,
wherein the processor calculates the second correlation coefficient by calculating a product of the first correlation coefficients.

3. The wireless communication device according to claim 1,
wherein the plurality of direction-of-arrival candidates and reception strength expectations of the plurality of antennas according to each of the plurality of direction-of-arrival candidates are stored in the memory in association with each other.

4. The wireless communication device according to claim 1,
wherein the processor
executes second calculation processing of calculating a third correlation coefficient of the plurality of antennas by using a reception strength expectation and the reception strength without using the first correlation coefficients for each of the plurality of direction-of-arrival candidates, and
estimates a second direction of arrival of the radio wave of the estimation target based on the third correlation coefficient for each of the direction-of-arrival candidates.

5. The wireless communication device according to claim 4,
wherein the processor executes the first calculation processing if a first condition for the second direction is satisfied.

6. The wireless communication device according to claim 5,
wherein the first condition includes that the second direction of arrival does not fall within a given angle range whichever antenna among the plurality of antennas is selected as an antenna whose high receiving sensitivity direction serves as a reference, or that the second direction of arrival falls within the given angle range based on high receiving sensitivity direction of one antenna among the plurality of antennas and difference between the reception strength of the one antenna and the reception strength of an adjacent antenna of the one antenna is up to a threshold.

7. The wireless communication device according to claim 1,
wherein the processor executes second calculation processing of calculating a third correlation coefficient of the plurality of antennas by using a reception strength expectation and the reception strength without using the first correlation coefficients for each of the plurality of direction-of-arrival candidates if a second condition for the first direction of arrival is satisfied.

8. The wireless communication device according to claim 7,
wherein the second condition includes that the first direction of arrival does not fall within a given angle range whichever antenna among the plurality of antennas is selected as an antenna whose high receiving sensitivity direction serves as a reference, or that the first direction of arrival falls within the given angle range based on high receiving sensitivity direction of one antenna among the plurality of antennas and difference between the reception strength of the one antenna and the reception strength of an adjacent antenna of the one antenna is up to a threshold.

9. An estimation method comprising:
measuring reception strength of a radio wave of an estimation target at each of a plurality of antennas;
executing, by a computer, first calculation processing of calculating first correlation coefficients of antenna pairs among the plurality of antennas and calculating a second correlation coefficient of the plurality of antennas by using the first correlation coefficients for each of a plurality of direction-of-arrival candidates of radio waves; and
estimating a first direction of arrival of the radio wave of the estimation target based on the first correlation coefficients for each of the direction-of-arrival candidates.

10. The estimation method according to claim 9,
wherein the second correlation coefficient is calculated by calculating a product of the first correlation coefficients.

11. The estimation method according to claim 9,
wherein the plurality of direction-of-arrival candidates and reception strength expectations of the plurality of antennas according to each of the plurality of direction-of-arrival candidates are stored in a memory in association with each other.

12. The estimation method according to claim 9, further comprising:
executing second calculation processing of calculating a third correlation coefficient of the plurality of antennas by using a reception strength expectation and the reception strength without using the first correlation coefficients for each of the plurality of direction-of-arrival candidates; and
estimating a second direction of arrival of the radio wave of the estimation target based on the third correlation coefficient for each of the direction-of-arrival candidates.

13. The estimation method according to claim 12,
wherein the first calculation processing is executed if a first condition for the second direction is satisfied.

14. The estimation method according to claim 13,
wherein the first condition includes that the second direction of arrival does not fall within a given angle range whichever antenna among the plurality of antennas is selected as an antenna whose high receiving sensitivity direction serves as a reference, or that the second direction of arrival falls within the given angle range based on high receiving sensitivity direction of one antenna among the plurality of antennas and difference between the reception strength of the one antenna and the reception strength of an adjacent antenna of the one antenna is up to a threshold.

15. The wireless communication device according to claim 9, further comprising:
executing second calculation processing of calculating a third correlation coefficient of the plurality of antennas by using a reception strength expectation and the reception strength without using the first correlation coefficients for each of the plurality of direction-of-arrival candidates if a second condition for the first direction of arrival is satisfied.

16. The estimation method according to claim 15,
wherein the second condition includes that the first direction of arrival does not fall within a given angle range whichever antenna among the plurality of antennas is selected as an antenna whose high receiving sensitivity direction serves as a reference, or that the first direction of arrival falls within the given angle range based on high receiving sensitivity direction of one antenna among the plurality of antennas and difference between the reception strength of the one antenna and the reception strength of an adjacent antenna of the one antenna is up to a threshold.
